(19) United States
(12) Patent Application Publication
(10) Pub. No.: US 2021/0125151 A1
(43) Pub. Date: Apr. 29, 2021

(54) SYSTEM, METHOD, AND COMPUTER PROGRAM FOR MANAGING TALENT EVENTS

(71) Applicant: Eightfold AI Inc., Mountain View, CA (US)

(72) Inventors: Yuet Ping Poon, Cupertino, CA (US); Varun Kacholia, Sunnyvale, CA (US); Ashutosh Garg, Sunnyvale, CA (US); Anthony Hahn, San Jose, CA (US)

(73) Assignee: Eightfold AI Inc., Mountain View, CA (US)

(21) Appl. No.: 17/082,821

(22) Filed: Oct. 28, 2020

Related U.S. Application Data
(60) Provisional application No. 62/927,362, filed on Oct. 29, 2019.

(51) Int. Cl. G06Q 10/10; G06N 20/00

(52) U.S. Cl. CPC G06Q 10/1053; G06N 20/00; G06Q 10/109

(57) ABSTRACT

A system and method for event management including a processing device to identify target participants from the event participants, and transmit a request for information to each of the target participants, generate a corresponding first enriched talent profile associated with the at least one target participant, implement a machine learning module that is trained based on historical recruiting data relating to at least one of a talent event or an organization to which the at least one target participant belongs, for a calibrated position profile, execute the trained machine learning module using the first enriched talent profiles and the calibrated position profile as inputs to calculate a match score associated with each of first enriched talent profiles, and determine, based on calculated match scores, one or more target participants invited to meet at the talent event.

### CROSS-REFERENCE TO RELATED APPLICATIONS

This application claims the benefit of U.S. Provisional Application 62/927,362 filed on Oct. 29, 2019.

### TECHNICAL FIELD

The present disclosure relates to managing events, and in particular to a system, method, and storage medium including executable computer programs for managing talent events.

### BACKGROUND

An organization may participate in different talent events, such as recruiting events to scout for potential candidates or retention events engaging current employees. The organization can be a company, a university, a nonprofit organization, or a government agency. The organization may be composed of employees and/or students. The employees of the organization may include experienced and new employees. The new employees may include fresh recruits from schools with little prior work experience. The students can be undergraduate or graduate students.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system for managing recruiting events according to an implementation of the disclosure.

FIG. 2 illustrates workflows in event manager application 108 according to an implementation of the disclosure.

FIG. 3 illustrates a system for managing recruiting events in detail according to an implementation of the disclosure.

FIG. 4 illustrates a flowchart of a method for managing recruiting events according to an implementation of the disclosure.

FIG. 5 depicts a block diagram of a computer system operating in accordance with one or more aspects of the present disclosure.

### DETAILED DESCRIPTION

Organization may participate different talent events including recruiting events or employee retention events. For example, organizations may need to recruit new employees and/or students (referred to as candidates) each year. To this end, an organization may attend recruiting events to scout for potential candidates. A recruiting event can be an onsite event or a virtual event sponsored by the organization or by multiple organizations (e.g., a job fair sponsored by these organizations). At the recruiting event, a recruiter of the organization may meet with multiple candidates (referred to as the “event participants”). Each event participant may be interested in one or more positions with the organization. The recruiter may need to identify, from the event participants, candidates for each of the openings of the organization. The recruiter may need, in a limited time period, to identify as many as possible high-quality potential candidates from the event participants, manage the information about these candidates, and project good impressions of the organization onto the event participants and candidates. Therefore, there is a need for a computer system that may intelligently facilitate a recruiter to manage the recruiting event.

Implementations of the disclosure provide a technical solution to assist a recruiter of an organization to overcome the above-identified and other challenges associated with managing talent events. Using the recruiting events as an example, the technical solution may include a software tool implemented on a computing system or in a computing cloud, the software tool including workflows integrated as one event manager application to provide GUI views of recruiting analytics, targeted outreach before the event, candidate experience at the event, recruiter experience at the event, and follow-up and nurturing after the event. Implementations of the disclosure help the recruiter work more efficiently and generate a high yield (or percentage) of candidates from a pool of event participants to the organization.

An organization may deploy enterprise information systems which may include application tracking systems (ATS) or similar human resource (HR) information systems that store personal records of potential candidates in addition to other personnel associated with the organization. Implementations of the disclosure may interact with the ATS to create and manage recruiting events to identify and invite potential candidates, automatically or semi-automatically schedule meetings with candidates, and record the candidate assessment details in the ATS. Further, for such organizations, the implementations may enable brand management and brand enhancement by personalizing the brand experience to the candidates.

From the perspective of a candidate, implementations of the disclosure may provide an easy-to-use user experience which may encourage a candidate to engage with the event and with the organizations and recruiters. The solution may allow the recruiter to interact with the candidate directly on site. A candidate using the solution can view questions that the candidate needs to answer for registration, where the questions are configurable by the recruiter. After providing details, the candidate may receive a notice (e.g., an e-mail) containing an acknowledgement with QR code (or registration number). Alternatively, the candidate may register using social network connections. Once logging in, the candidate may be provided with information customized to the candidate. For example, the candidate for a job fair may be provided with ranked job positions in a graphical user interface to allow the candidate to selectively apply for one or multiple job positions out of a list of jobs.

The implementations of the disclosure may offer flexibility to identify relevant prospects, create multiple impactful event promotion, registration and reminder communication. It may automate certain tasks surrounding the event management, such as automation of reminder tasks.

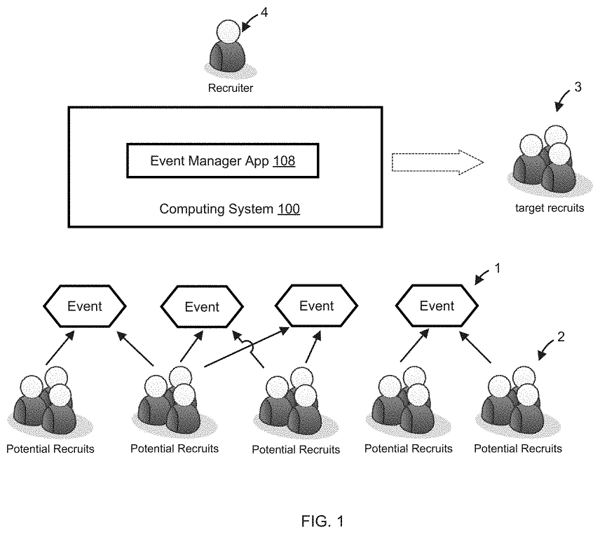

FIG. 1 illustrates a system 100 for managing recruiting events according to an implementation of the disclosure. An organization may host and/or attend recruiting events 1 that are designed to introduce the organization to potential candidates 2 and identify target candidates 3 based on certain criteria. The organization can be a company that may need to recruit new employees of experienced workers or new graduates at recruiting events 1. Recruiting events 1 can be a face-to-face meeting event at a physical facility or a virtual meeting through a video conference. These recruiting events 1 may occur at different times through different venues. Each event may have one or more participating organizations and a large number of candidate participants. For an employer organization such as a company, the potential candidates can be job candidates such as new college graduates or people who are in the job market. For an education organization such as a university, the potential candidates can be high school students seeking to enroll in the education organization. A recruiter 4 associated with an organization may be responsible for managing these recruiting events on behalf of the organization. Instead of random meetings, the recruiter 4 may want to use the recruiting events 1 to project a good impression of the organization and attract candidates 2 with the most potentials. To this end, the recruiter 4 may need to select, based on certain criteria, target candidates 3, invite these target candidates 3 to submit an application (e.g., filling out an application form and submitting a resume), arrange meetings with these target candidates 3 at the recruiting events, and select some of the target candidates 3 for further interviews. After the recruiting events, the recruiter 4 may also need to follow up with the selected target candidates and maintain relationships with unselected candidates for the future. Thus, there is a need for computer-implemented software tools that can assist the recruiter 4 to manage recruiting events 1.

In one implementation, system 100 may include a processing device configured to implement an event manager application 108. Event manager application 108 may provide functions to assist the recruiter 4 managing different aspects of recruiting events 2 and resolve the practical problems arising in managing recruiting events.

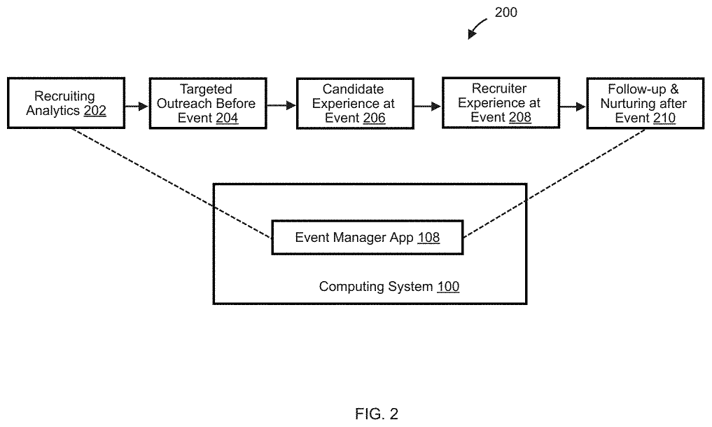

Event manager application 108 may include workflows to address the different aspects of event management. A workflow is a software component that may automate steps in managing recruiting events, thus reducing the workload of the recruiter and achieving results beyond the capability of the recruiter. FIG. 2 illustrates workflows 200 in event manager application 108 according to an implementation of the disclosure. Workflows 200 may include a recruiting analytics workflow 202, a target outreach workflow 204, a candidate experience workflow 206, a recruiter experience workflow 208, and a follow-up nurturing workflow 210. These workflows 200 may be integrated in event manager application 108 to assist the recruiter to work more efficiently and generate a high yield (or percentage) of target candidates from a pool of event participants.

In one implementation, recruiting analytics workflow 202 may provide graphical user interface (GUI) views of historical recruiting data derived from past recruiting events. The historical data can be statistical data derived from past recruiting events including conversion rates for different scenarios. For example, the statistical data may include a conversion rate from a number of applications received to a number of applications reviewed by the recruiter, a conversion rate from the number of applications reviewed by the recruiter to a number of applications reviewed by a hiring manager, a conversion rate from the number of applications reviewed by the hiring manager to a number of candidates interviewed by the organization, and a conversion rate from the number of candidates interviewed by the organization to the number of candidates finally hired. The statistical data may also include venue-specific data, where the venue can be a school or an event. For example, the statistical data may include the venue-specific numbers of offers extended, offers accepted, offers declined, and offers pending. To provide intuitive views to the recruiter, recruiting analytics workflow 202 may also provide visualizations of these statistical data in GUI views. Recruiting analytics workflow 202 may generate and present information that is useful to the recruiting manager and to other workflows.

Target outreach workflow 204 may intelligently automate the process of selecting target candidates from potential candidates, where the potential candidates can be participants to a recruiting event whose backgrounds may be relevant to the recruiting organization, and the target candidates can be those selected, based on certain selection criteria, for further information. The selection of target participants may reduce the amount of profiles that the recruiter needs to review and increase the conversion rates from event participants to qualified candidates to the recruiting organization. Target outreach workflow 204 may calculate a ranking of the event participants using a machine learning module (e.g., a neural network module). For example, in the context of an on-campus recruiting event, the ranking may be based on factors such as disciplines of study, coursework, academic performance etc. In one implementation, target outreach workflow 204 may use the machine learning module to calculate the ranking. The machine learning module may include a neural network module trained using historical data from past recruiting events and associated past hiring decisions (such as interviewed, made offer, no offer, hired, or did not accept offer). The historical data may also include decisions made in hiring similar roles in normal hiring process other than the recruiting events. The training of the neural network module may include adjusting parameters of the neural network module based on the historical data from past recruiting events, where the historical data from past recruiting events may have been labeled with a ranking for each participant of recruiting events. Thus, target outreach workflow 204 may execute the trained neural network module using information of event participants of the present recruiting event as inputs to calculate the ranking of these event participants. Target outreach workflow 204 may further determine, based on the ranking of these event participants, target participants for a meeting at the present recruiting event. The determination of the target participants can be based on a certain criteria such as those whose ranking is a higher than a pre-determined threshold value (e.g., top 50 potential candidates). Alternatively, target outreach workflow 204 may present the ranking in a GUI view for the recruiter to select. Responsive to determining the target participants, target outreach workflow 204 may generate and transmit a request for information to each of the target participant. The request may include an e-mail containing an instruction to the recruiting event, an introduction to the recruiting organization, a letter to recipient, and an hyperlink for the recipient to submit application materials (e.g., a resume, a cover letter).

Candidate experience workflow 206 may include a process to determine a subset of target participants who may be invited to meet the recruiter at the recruiting event. Candidate experience workflow 206 may receive application materials submitted by some of the target participants who are interested in meeting the recruiter at the recruiting event. For a target participant who submits application materials, candidate experience workflow 206 may generate an enriched talent profile. The enrich talent profile may include a profile (e.g., a resume) received in the application materials from the target participant. The candidate experience workflow 206 may supplement the enriched talent profile with other data points relating to the target participant. The other data points may include information from the social network profiles (e.g., LinkedIn Profile), publications, open source contributions etc. The enriched talent profile may also include assessments of the target participant such as recommendation letters or machine-generated assessment of the traits and characters of the target participant.

Candidate experience workflow 206 may implement another machine learning module to determine how well the target participant is matched to open positions at the recruiting organization. The machine learning module may be trained using historical recruiting data. In some implementations, the machine learning module may be trained using historical recruiting data specific to a particular event (e.g., annual job fair) or to a particular organization to which the target participant belongs (e.g., a high education institute). In this way, the machine learning module may be customized for a particular situation to provide more accurate matching measurements. For each open position of the recruiting organization, candidate experience workflow 206 may generate a calibrated position profile which may include requirements for the position and other data points related to the position. In one implementation, the other data points may include enriched talent profiles of past event participants who have successfully undergone the recruiting processing. Candidate experience workflow 206 may further execute the trained machine learning module using the enriched talent profile of the target participant and the calibrated position profile as inputs to calculate a match score between the enriched talent profile and the calibrated position profile. The match score may indicate how well the target participant is matched to the open position. Candidate experience workflow 206 may use the machine learning module to calculate match scores between each of the target participants who are interested in the recruiting event and each open position. Candidate experience workflow 206 may then determine a group of target participants based on the match scores (e.g., by comparing the match scores against a threshold value) and extend an invitation to each one in the group of target participants as candidates for meeting at the recruiting event.

In one implementation, candidate experience workflow 206 may generate and transmit a personalized invitation for each one in the group of target participants. The personalized invitation may include a personalized description of the open position. The personalized description may include the hiring statistics of the organization to which the target participant belongs, highlights of the target participant's credentials (e.g., skills, experience) that match requirements of the open position, and past alumni of the target participant who were hired by the recruiting organization. The personalized description may provide relevant information to the target participant and thus encourage the target participant to accept the invitation to meet at the recruiting event.

Recruiter experience workflow 208 may assist the recruiter to manage information relating to recruiting events. Since a recruiter may be responsible for multiple recruiting events concurrently and the recruiting organization may need to review hundreds of participant profiles, there is a need for software tools for the recruiter to manage the large amount of information. After candidate experience workflow 206 identifies and invites target participants, recruiter experience workflow 208 may generate an event participant view including icons representing the target participants. Each icon may provide drill-down views for detailed information about the target participant. The drill-down views may include a summary view of information associated with the targeted participant (e.g., name, school/association, matching positions, match scores etc.), a status view indicating the meeting schedule and status at the event (e.g., meeting time and location), notes and suggested questions for the recruiter to ask at the meeting, an assessment or impression of the target participant after the meeting, and an evaluation view for a formal evaluation of the target participant after interview.

Follow-up nurturing workflow 210 may include following-up e-mail pages and invitations to future events by the recruiting organization and by other organizations based on the match score, insights and assessment information collected during the event.

Implementations of the disclosure may include a computing system including one or more computers for managing recruiting events for a recruiting organization. The one or more computers include an interface device and a processing device, communicatively connected to the interface device to execute one or more workflows. The processing device is to identify, based on a ranking of event participants to a recruiting event, target participants from the event participants, and transmit a request for information to each of the target participants; responsive to receiving a first document submitted by at least one of the target participants, generate, based on the first document, a corresponding first enriched talent profile associated with the at least one target participant; implement a machine learning module that is trained based on historical recruiting data relating to at least one of the recruiting event or an organization to which the at least one target participant belongs; for a calibrated position profile, execute the trained machine learning module using the first enriched talent profiles and the calibrated position profile as inputs to calculate a match score associated with each of first enriched talent profiles; and determine, based on calculated match scores, one or more target participants invited to meet at the recruiting event.

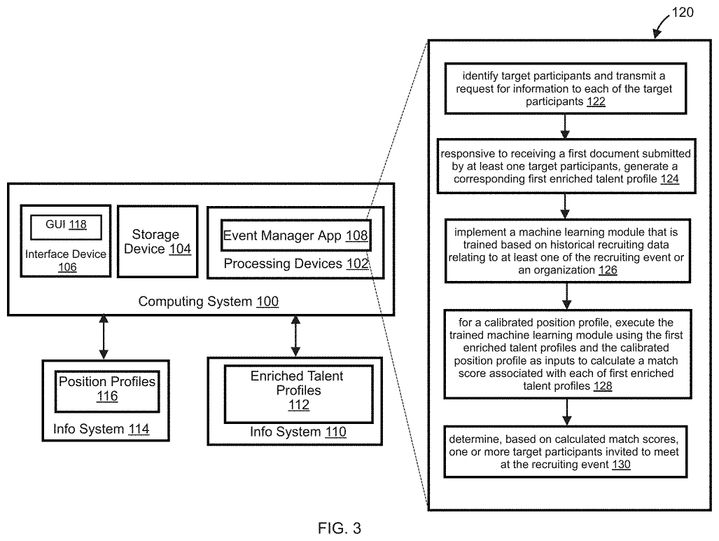

These workflows may be implemented using a computing system. FIG. 3 illustrates a system 100 for managing recruiting events according to an implementation of the disclosure. System 100 can be a standalone computer system or a networked computing resource implemented in a computing cloud. Referring to FIG. 3, system 100 may include a processing device 102, a storage device 104, and an interface device 106, where the storage device 104 and the interface device 106 are communicatively coupled to processing device 102.

Processing device 102 can be a hardware processor such as a central processing unit (CPU), a graphic processing unit (GPU), or an accelerator circuit. Interface device 106 can be a display such as a touch screen of a desktop, laptop, or smart phone. Storage device 104 can be a memory device, a hard disc, or a cloud storage connected to processing device 102 through a network interface card (not shown).

Processing device 102 can be a programmable device that may be programmed to implement a graphical user interface 118 presented on interface device 106. Graphical user interface (“GUI”) 118 allows a user to view graphic representations presented on interface device 106, and allows using an input device (e.g., a keyboard, a mouse, and/or a touch screen) to interact with graphic representations (e.g., icons) presented on GUI 118. In one implementation, GUI 118 may include graphic representations representing graphical views of data relating to event manager application 108. For example, GUI 118 may also include graphic representations representing event participants, target participants etc.

Computing system 100 may be connected to other information systems 110, 114 through network (not shown). These information systems can be human resource management (HRM) systems that are associated with same or different organizations. The HRM systems can track external/internal candidate information in the pre-hiring phase (e.g., using an applicant track system (ATS)), or track employee information after they are hired (e.g., using an HR information system (HRIS)). Thus, these information systems may include databases that contain information relating to candidates and current employees.

In one implementation, information system 110 may include a database that stores talent profiles 112 associated with one or more organizations. A talent profile can be a data object that contains data points related to an employee including current and previous employees as well as candidates that had participated in recruiting events attended by the organization. The collection of talent profiles 112 stored in information system 110 may represent the information describing all employees that are working for and have worked for the organization, and candidates. In some implementations, the talent profile 112 may include a job title held by the employee or applied by the candidate, the technical or non-technical skills possessed by the employee for performing the job held by the employee or applied by the candidate, and the location (e.g., city and state) of the employee or candidate. Examples of technical skills may include programming languages and knowledge of software platforms; examples of non-technical skills may include administrative skills such as implementing a certain regulatory policy. The talent profile 112 may further include the employee or candidate's education background information including schools he or she has attended, fields of study, and degrees obtained. The talent profile 112 may further include other professional information of the employee or candidate such as professional certifications the employee has obtained, achievement awards, professional publications, and technical contributions to public forums (e.g., open source code contributions). In addition to these fact-based data points, the talent profile may also be enriched to include derived information relating to the employee. For example, talent profile 112 may include predicted values that indicate the likely career path through the organization if the employee or candidate stays with the organization for a certain period of time. The career path may indicate the potential of the employee or candidate with the organization.

Computing system 100 may be connected to information systems 114 that may belong to the recruiting organization that may be in the market to recruit employees or students. Information system 114 may include position profiles 116 that specify different aspects of the open position. In one implementation, a position profile may include specifications about the job such as job titles, job functions, prior experiences, a list of job skills requested for performing the job, requisite education, degrees, certificates, licenses etc. The position profiles may also include desired personality traits of the candidates such as leadership attributes, social attributes, and altitudes. Additionally, these position profiles are stored in a database and are searchable by using a query such as the position title.

In one implementation, processing devices 102 may execute an event manager application 108 that may include workflows (e.g., workflows 200 as shown in FIG. 2) for managing different aspects of recruiting events. Event manager application 108 can be a standalone application executed by processing devices. A recruiter of a recruiting organization may use event manager application 108 to efficiently manage recruiting events.

Event manager application 108 when executed by processing devices 102 may perform operations. At 122, processing device 102 may identify, based on a ranking of event participants to a recruiting event, target participants from the event participants, and transmit a request for information to each of the target participants. The recruiting event can be an event for recruiting new employees or for new students. An event participant can be a person in the market for a new job or seeking admission to a college. The processing device 102 may have calculated the ranking of event participants based on a certain criteria. In one implementation, the ranking may be calculated using a ranking machine learning module that had been trained using historical recruiting data stored in information system 110. The ranking machine learning module may include a neural network module trained using historical data from past recruiting events including rankings of event participants. The training of the neural network module may include adjusting parameters of the neural network module based on the historical data from past recruiting events, where the historical data from past recruiting events may have been labeled with a ranking for each participant of recruiting events. Processing device 102 may execute the trained neural network module using information of event participants of the present recruiting event as inputs to calculate the ranking of these event participants. Based on the ranking, processing device 102 may identify target participants that interest the recruiting organization. The determination of the target participants can be based on a certain criteria such as those whose ranking is a higher than a predetermined threshold value (e.g., top 50 potential candidates). Alternatively, target outreach workflow 204 may present the ranking in a GUI view for the recruiter to select. After identifying the target participants that the recruiting organization may be interested in recruiting, processing device 102 may generate and transmit a request for information to each of the identified target participants. The request may include an e-mail containing an instruction to the recruiting event, an introduction to the recruiting organization, a letter to recipient, and an hyperlink for the recipient to submit application materials (e.g., a resume, a cover letter). The hyperlink may allow a willing target participant to log into a portal of the recruiting organization to submit his or her application materials.

At 124, responsive to receiving a first document submitted by at least one of the target participants, processing device may generate, based on the first document, a corresponding first enriched talent profile associated with the at least one target participant. Processing device 102 may generate an enriched talent profile based on the application materials submitted by each target participant, and generate the enriched talent profile for the corresponding target participant. As discussed above, the enrich talent profile may include a profile (e.g., a resume) received in the application materials from the target participant. Processing device 102 may supplement the enriched talent profile with other data points relating to the target participant. The other data points may include information from the social network profiles (e.g., LinkedIn Profile), publications, open source contributions etc. The enriched talent profile may also include assessments of the target participant such as recommendation letters or machine-generated assessment of the traits and characters of the target participant.

At 126, processing device 102 may implement a machine learning module that is trained based on historical recruiting data relating to at least one of the recruiting events or an organization to which the at least one target participant belongs. This machine learning module may be trained to identify qualified candidates to open positions at the recruiting organization. The machine learning module may be trained using historical recruiting data. The historical recruiting data may include enriched profiles of past recruits and matching calibrated position profiles. In some implementations, the machine learning module may be trained using historical recruiting data specific to a particular event (e.g., annual job fair) or to a particular organization to which the target participant belongs (e.g., a high education institute). In this way, the machine learning module may be customized for a particular situation to provide more accurate matching measurements.

At 128, for a calibrated position profile, processing device 102 may execute the trained machine learning module using the first enriched talent profiles and the calibrated position profile as inputs to calculate a match score associated with each of first enriched talent profiles. For each open position (represented by position profiles 116) available at the recruiting organization, processing device 102 may generate a calibrated position profile which may include requirements for the position and other data points related to the position. In one implementation, the other data points may include enriched talent profiles of past event participants who have successfully undergone the recruiting processing. Processing device 102 may further execute the trained machine learning module using the enriched talent profile of the target participant and the calibrated position profile as inputs to calculate a match score between the enriched talent profile and the calibrated position profile. The match score may indicate how well the target participant is matched to the open position. For example, the match score may be in a range of [0, 1] with higher value indicating a better match. Processing device 102 may employ the machine learning module to calculate a corresponding match score between each of the target participants who are interested in the recruiting event and each open position.

At 130, processing device 102 may determine, based on calculated match scores, one or more target participants invited to meet at the recruiting event. Processing device 102 may then determine a group of target participants based on the match scores (e.g., by comparing the match scores against a threshold value) and extend an invitation to each one in the group of target participants as candidates for meeting at the recruiting event.

In one implementation, processing device 102 may generate and transmit a personalized invitation for each one in the group of target participants to apply for positions matching the target participants. The personalized invitation may include a personalized description of the open position. The personalized description may include the hiring statistics of the organization to which the target participant belongs, highlights of the target participant's credentials (e.g., skills, experience) that match requirements of the open position, and past alumni of the target participant who were hired by the recruiting organization. The personalized description may provide relevant information to the target participant and thus encourage the target participant to accept the invitation to meet at the recruiting event. In this way, the recruiting event may yield a high percentage of qualified candidates from the event participants.

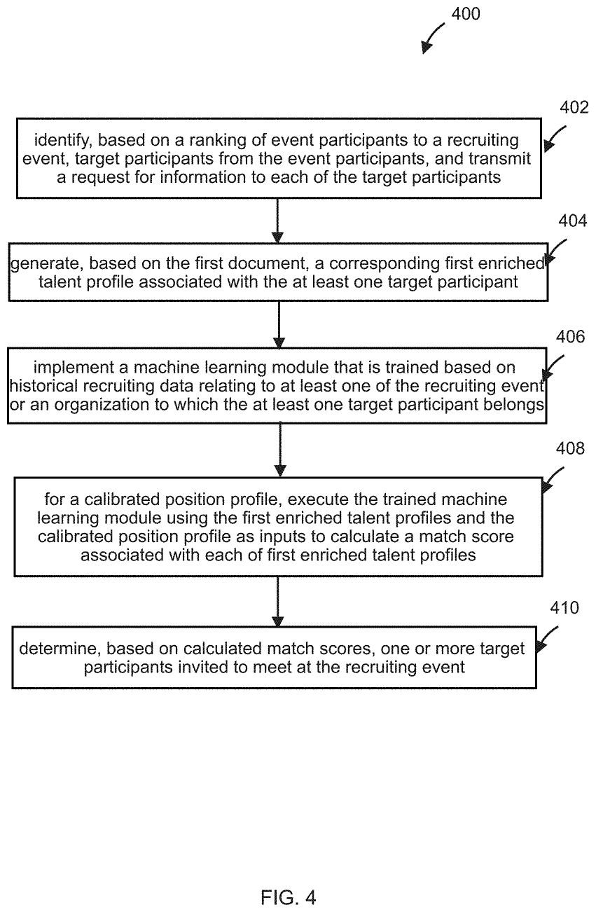

FIG. 4 illustrates a flowchart of a method 400 for managing recruiting events according to an implementation of the disclosure. Method 400 may be performed by processing devices that may comprise hardware (e.g., circuitry, dedicated logic), computer readable instructions (e.g., run on a general purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processing device 102 executing event manager application 108 as shown in FIG. 1.

As shown in FIG. 4, processing device 102 may, at 402, identify, based on a ranking of event participants to a recruiting event, target participants from the event participants, and transmit a request for information to each of the target participants.

At 404, responsive to receiving a first document submitted by at least one of the target participants, processing device 102 may generate, based on the first document, a corresponding first enriched talent profile associated with the at least one target participant.

At 406, processing device 102 may implement a machine learning module that is trained based on historical recruiting data relating to at least one of the recruiting event or an organization to which the at least one target participant belongs.

At 408, processing device may for a calibrated position profile, execute the trained machine learning module using the first enriched talent profiles and the calibrated position profile as inputs to calculate a match score associated with each of first enriched talent profiles.

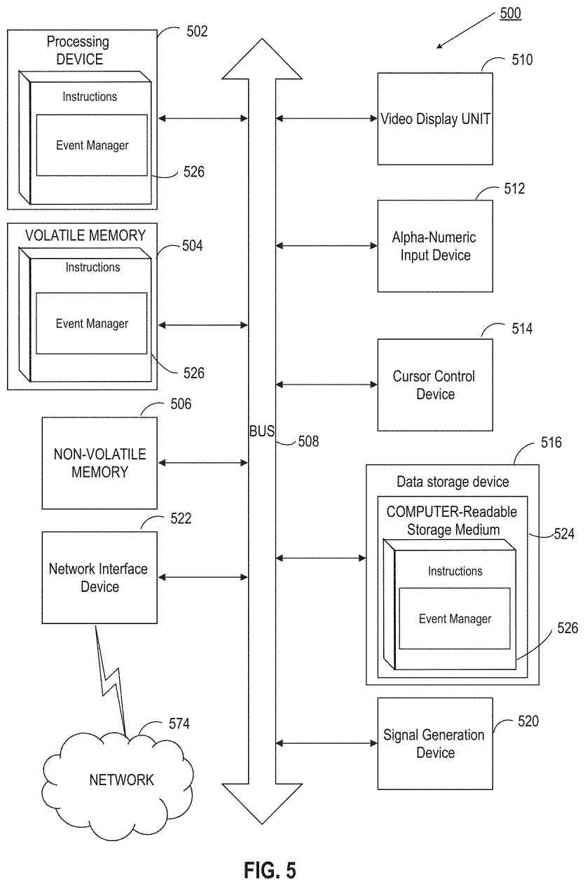

FIG. 5 depicts a block diagram of a computer system operating in accordance with one or more aspects of the present disclosure. In various illustrative examples, computer system 500 may correspond to the processing device 102 of FIG. 3.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions of the event manager application 108 of FIG. 3 for implementing method 400.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A computing system comprising one or more computers for managing talent events for an employer organization, the one or more computers comprising:
an interface device; and
a processing device, communicatively connected to the interface device to execute one or more workflows, to:
identify, based on a ranking of event participants to a talent event, target participants from the event participants, and transmit a request for information to each of the target participants;
responsive to receiving a first document submitted by at least one of the target participants, generate, based on the first document, a corresponding first enriched talent profile associated with the at least one target participant;
implement a machine learning module that is trained based on historical recruiting data relating to at least one of the talent event or an organization to which the at least one target participant belongs;
for a calibrated position profile, execute the trained machine learning module using the first enriched talent profiles and the calibrated position profile as inputs to calculate a match score associated with each of first enriched talent profiles; and
determine, based on calculated match scores, one or more target participants invited to meet at the talent event.

2. The computing system of claim 1, wherein the processing device is further to:
receive historical recruit data of past talent events and hire decisions, wherein the historical recruiting data comprise at least one of conversion rates from a number of resumes received to one of interviewed or offer made, offer accept rates with respect to one of event venues or schools attended by the potential participants, offer decline rates with respect to the event venues or the schools attended by the event participants, or pending offers with respect to the event venues or the schools attended by the event participants; and
present, on a graphical user interface of the interface device, the historical recruiting data.

3. The computing system of claim 1, wherein the processing device is further to:
implement a second machine learning module that is trained by adjusting at least one parameter of the second machine learning module based on information of past event participants to the talent event and the historical recruiting data, the information of past event participants to the talent event including at least one of courses taken, academic performance, projects accomplished, jobs held, or awards received by past event participants to the talent event;
identify information of the event participants to the talent event; and
execute the second machine learning module using the information of the event participants as inputs to calculate the ranking of event participants to the talent event.

4. The computing system of claim 1, wherein the first document comprises a resume submitted by the at least one of the target participants, and wherein the enrich talent profile comprises the resume, and at least one of:
first data items relating to at least one peer of the at least one target participant, and wherein the at least one peer is a past event participant of the talent event,
second data items relating to skills, companies, roles, schools, and fields of study similar to the at least one target participant's skills, companies, roles, schools, and fields of study,
third data items relating to at least one of a personality or a talent assessment for the at least one target participant based on the resume of the at least one target participant, or
a predicted data item comprising at least one of a future role, a future company, a future school, or a future field of study for the at least one target participant.

5. The computing system of claim 1, wherein the calculated match score represents a probability for a target participant to be interviewed or hired by the recruiting organization with respect to a particular position.

6. The computing system of claim 1, wherein the processing device is further to:
generate and transmit a customized invitation to each of the one or more target participants, wherein the customized invitation comprises at least one of a position description, the historical recruiting data relating to at least one of the talent event or the organization to which the corresponding target participant belongs to, a list of credentials possessed by the corresponding target participant that match one or more requirements in the position description, or information of a list of personnel who is currently associated with the recruiting organization.

7. The computing system of claim 1, wherein the processing device is further to generate a second graphical user interface to a recruiter, wherein the second graphical user interface comprises the potential participants and the target participants.

8. The computing system of claim 7, wherein responsive to selecting a third target participant in the second graphical user interface, the processing device is further to present drill-down views relating to the selected third target participant comprising at least one of:
a summary view of information associated with the third target participant;
a status view indicating a meeting schedule and status of the third target participant at the talent event;
a list of questions for the recruiter to direct at the third target participant, wherein the list of questions are customized for the third target participant; or
an evaluation view for the recruiter to evaluate the third target participant after meeting the third target participant.

9. The computing system of claim 1, wherein the processing device is further to generate a third graphical user interface to present a communication page for inviting a fourth target participant to participate in a future event based on a corresponding match score associated with the fourth target participant.

10. A method for managing talent events for a recruiting organization, the method comprising:
identifying, by a processing device based on a ranking of event participants to a talent event, target participants from the event participants, and transmit a request for information to each of the target participants;
responsive to receiving a first document submitted by at least one of the target participants, generating, based on the first document, a corresponding first enriched talent profile associated with the at least one target participant;
implementing a machine learning module that is trained based on historical recruiting data relating to at least one of the talent event or an organization to which the at least one target participant belongs;
for a calibrated position profile, executing the trained machine learning module using the first enriched talent profiles and the calibrated position profile as inputs to calculate a match score associated with each of first enriched talent profiles; and
determining, based on calculated match scores, one or more target participants invited to meet at the talent event.

11. The method of claim 10, further comprising:
receiving historical recruit data of past talent events and hire decisions, wherein the historical recruiting data comprise at least one of conversion rates from a number of resumes received to one of interviewed or offer made, offer accept rates with respect to one of event venues or schools attended by the potential participants, offer decline rates with respect to the event venues or the schools attended by the event participants, or pending offers with respect to the event venues or the schools attended by the event participants; and
presenting, on a graphical user interface, the historical recruiting data.

12. The method of claim 10, further comprising:
implementing a second machine learning module that is trained by adjusting at least one parameter of the second machine learning module based on information of past event participants to the talent event and the historical recruiting data, the information of past event participants to the talent event including at least one of courses taken, academic performance, projects accomplished, jobs held, or awards received by past event participants to the talent event;
identifying information of the event participants to the talent event; and
executing the second machine learning module using the information of the event participants as inputs to calculate the ranking of event participants to the talent event.

13. The method of claim 10, wherein the first document comprises a resume submitted by the at least one of the target participants, and wherein the enrich talent profile comprises the resume, and at least one of:
first data items relating to at least one peer of the at least one target participant, and wherein the at least one peer is a past event participant of the talent event,
second data items relating to skills, companies, roles, schools, and fields of study similar to the at least one target participant's skills, companies, roles, schools, and fields of study,
third data items relating to at least one of a personality or a talent assessment for the at least one target participant based on the resume of the at least one target participant, or
a predicted data item comprising at least one of a future role, a future company, a future school, or a future field of study for the at least one target participant.

14. The method of claim 10, wherein the calculated match score represents a probability for a target participant to be interviewed or hired by the recruiting organization with respect to a particular position.

15. The method of claim 10, further comprising:
generating and transmitting a customized invitation to each of the one or more target participants, wherein the customized invitation comprises at least one of a position description, the historical recruiting data relating to at least one of the talent event or the organization to which the corresponding target participant belongs to, a list of credentials possessed by the corresponding target participant that match one or more requirements in the position description, or information of a list of personnel who is currently associated with the recruiting organization.

16. The method of claim 10, further comprising generating a second graphical user interface to a recruiter, wherein the second graphical user interface comprises the potential participants and the target participants.

17. The method of claim 16, further comprising:
responsive to selecting a third target participant in the second graphical user interface, presenting drill-down views relating to the selected third target participant comprising at least one of:
a summary view of information associated with the third target participant;
a status view indicating a meeting schedule and status of the third target participant at the talent event;
a list of questions for the recruiter to direct at the third target participant, wherein the list of questions are customized for the third target participant; or
an evaluation view for the recruiter to evaluate the third target participant after meeting the third target participant.

18. The method of claim 10, further comprising generating a third graphical user interface to present a communication page for inviting a fourth target participant to participate in a future event based on a corresponding match score associated with the fourth target participant.

19. A machine-readable non-transitory storage media encoded with instructions that, when executed by one or more computers, cause the one or more computer to implement a system for managing talent events for a recruiting organization, to:
identify, based on a ranking of event participants to a talent event, target participants from the event participants, and transmit a request for information to each of the target participants;
responsive to receiving a first document submitted by at least one of the target participants, generate, based on the first document, a corresponding first enriched talent profile associated with the at least one target participant;
implement a machine learning module that is trained based on historical recruiting data relating to at least one of the talent event or an organization to which the at least one target participant belongs;
for a calibrated position profile, execute the trained machine learning module using the first enriched talent profiles and the calibrated position profile as inputs to calculate a match score associated with each of first enriched talent profiles; and
determine, based on calculated match scores, one or more target participants invited to meet at the talent event.
